(19) United States
(12) Patent Application Publication
(10) Pub. No.: US 2019/0329513 A1
(43) Pub. Date: Oct. 31, 2019

(54) A BOX TEMPLATE PRODUCTION SYSTEM AND METHOD

(71) Applicant: Packsize LLC, Salt Lake City, UT (US)

(72) Inventors: Niklas Pettersson, Västerås (SE); Johan Blomberg, Uppsala (SE); Graziano Bertolini, Enköping (SE); Björn Thunell, Enköping (SE); Ryan Osterhout, West Haven, UT (US)

(21) Appl. No.: 16/310,406

(22) PCT Filed: Jun. 8, 2017
(86) PCT No.: PCT/US2017/036603

§ 371 Date: Dec. 14, 2018

Related U.S. Application Data
(60) Provisional application No. 62/351,127, filed on Jun. 16, 2016.
(60) Provisional application No. 62/425,457, filed on Nov. 22, 2016.

(30) Foreign Application Priority Data
Dec. 19, 2016 (SE) 1651682-5

(51) Int. Cl. B31B 50/00; B31B 50/02; B31B 50/04; B31B 50/10; B31B 70/14; B31B 70/16; B31B 70/00

(52) U.S. Cl. CPC B31B 50/006; B31B 50/022; B31B 50/046; B31B 70/25; B31B 70/14; B31B 70/16; B31B 50/106

(57) ABSTRACT

A method and a box template production system comprising a converting part which is configured for converting a fanfolded sheet material into box templates, wherein said converting is accomplished to the sheet material when a feed direction of the sheet material through the converting part of the system is along an axis having an angle towards a plane of a floor onto which the system stands, wherein said angle is between 20 and 90 degrees.

### TECHNICAL FIELD OF THE INVENTION

The present invention relates to a box template production system and a method for converting a fanfolded sheet material into box templates.

### RELATED ART

Shipping and packaging industries frequently use cardboard and other sheet material processing equipment that converts sheet materials into box templates. One advantage of such equipment is that a shipper may prepare boxes of required sizes as needed in lieu of keeping a stock of standard, pre-made boxes of various sizes. Consequently, the shipper can eliminate the need to forecast its requirements for particular box sizes as well as to store pre-made boxes of standard sizes. Instead, the shipper may store one or more bales of fanfold material, which can be used to generate a variety of box sizes based on the specific box size requirements at the time of each shipment. This allows the shipper to reduce storage space normally required for periodically used shipping supplies as well as reduce the waste and costs associated with the inherently inaccurate process of forecasting box size requirements, as the items shipped and their respective dimensions vary from time to time.

In addition to reducing the inefficiencies associated with storing pre-made boxes of numerous sizes, creating custom sized boxes also reduces packaging and shipping costs. In the fulfillment industry it is estimated that shipped items are typically packaged in boxes that are about 65% larger than the shipped items. Boxes that are too large for a particular item are more expensive than a box that is custom sized for the item due to the cost of the excess material used to make the larger box. When an item is packaged in an oversized box, filling material (e.g., Styrofoam, foam peanuts, paper, air pillows, etc.) is often placed in the box to prevent the item from moving inside the box and to prevent the box from caving in when pressure is applied (e.g., when boxes are taped closed or stacked). These filling materials further increase the cost associated with packing an item in an oversized box.

Customized sized boxes also reduce the shipping costs associated with shipping items compared to shipping the items in oversized boxes. A shipping vehicle filled with boxes that are 65% larger than the packaged items is much less cost efficient to operate than a shipping vehicle filled with boxes that are custom sized to fit the packaged items. In other words, a shipping vehicle filled with custom sized packages can carry a significantly larger number of packages, which can reduce the number of shipping vehicles required to ship the same number of items. Accordingly, in addition or as an alternative to calculating shipping prices based on the weight of a package, shipping prices are often affected by the size of the shipped package. Thus, reducing the size of an item's package can reduce the price of shipping the item. Even when shipping prices are not calculated based on the size of the packages (e.g., only on the weight of the packages), using custom sized packages can reduce the shipping costs because the smaller, custom sized packages will weigh less than oversized packages due to using less packaging and filling material.

A typical box template production system includes a converting part that cuts, scores, and/or creases sheet material to form a box template. The sheet material is provided to the system from fanfolded bales and needs to be guided correctly into the converting part of the system. Prior art systems often guide the sheet material up and over a top position by means of wheels or rails and down again to a suitable working height for entering the converting part of the system. The converting part is positioned such that the box template is delivered out from the converting part for example directly on a work table or conveyor belt provided next to the outlet of the system for further processing of the box template into a box. The guiding of the sheet material from the bales into the converting part of the machine requires force and precision. The force required is a function of the amount of material that is being accelerated, and how much friction is created due to its bending through the guide system, and the force required to control the precise direction of the material. It is therefore essential to limit these factors. This guiding of sheet material also requires space in the room.

### SUMMARY

An object of the present invention is to provide an improved method for converting a fanfolded sheet material into a box template and an improved box template production system.

This is achieved in a box template production system and a method according to the independent claims.

In one aspect of the invention a box template production system comprising a converting part which is configured for converting a fanfolded sheet material into box templates is provided. Said converting is accomplished to the sheet material when a feed direction of the sheet material through the converting part of the system is along an axis having an angle towards a plane of a floor onto which the system stands, wherein said angle is between 20 and 90 degrees.

In another aspect of the invention a method for converting a fanfolded sheet material into a box template is provided. Said method comprises the steps of:
feeding the sheet material into a box template production system;
converting the sheet material into box templates when a feed direction of the sheet material through a converting part of the box template production system is along an axis having an angle towards a plane of a floor onto which the system stands, wherein said angle is between 20 and 90 degrees.

Hereby a method for converting a fanfolded sheet material into a box template and a box template production system is achieved where reduced force is needed for guiding the sheet material into the converting part of the system. Furthermore reduced space is needed for this system compared to prior art systems because of the shortened way to travel for the sheet material before it enters the converting part of the system.

In one embodiment of the invention said angle is between 30 and 70 degrees.

In one embodiment of the invention said fanfolded sheet material is provided to the system from at least one fanfold bale positioned at an inlet side of the system, wherein said box template production system comprises at least one feed guide configured for receiving the sheet material from the fanfold bale and guiding it up to a top position, wherein the converting part of the system is configured for receiving the sheet material from the at least one feed guide or from one or more connecting guide parts on its way down from the top position.

In one embodiment of the invention only one feed guide is provided for each sheet material and said feed guide is configured for receiving the sheet material such that it slides over the feed guide. The at least one feed guide is configured for allowing the sheet material to tilt sideways around the feed guide on its way up to the top position thereby enabling correction of the feeding direction of the sheet material. Correction might be needed due to a material bale that is off the nominal position, or placed at an angle towards the feeding direction. Hereby the guiding of the sheet material will be facilitated and will be requiring less force. A shorter transport way before the sheet material enters the converting part and reduced friction will require less force than in prior art systems. Furthermore a fanfold bale provided in a slightly wrong position at the inlet to the system can still be handled because the direction of the sheet material through the system can be corrected.

In one embodiment of the invention the at least one feed guide is provided as an arc starting at a start position where the sheet material is provided to the feed guide, said arc further comprising the top position, wherein said feed guide has a width being less than one fifth of the width of the sheet material.

In one embodiment of the invention the system comprises a printer configured and positioned for printing on the sheet material in a direction being perpendicular to the feed direction of the sheet material when the sheet material is converted in the converting part of the system. Because of the tilted position of the printer printing capabilities are improved compared to prior art systems where printing often is provided directly from below, i.e. an underside of the sheet material is printed because this will later be an outside of the box and the printer is often provided together with the converting part in the system. However printing upwards is not ideal because dust and dirt can cover the printer heads and gravity force can counteract the printing effectivity. Hereby with this system the printing is provided to the sheet material not directly from below but from an angle corresponding to the angle defined above. This provides a more effective printing system which is less prone to the problems caused by dirt and dust covering the printer heads.

### BRIEF DESCRIPTION OF THE DRAWINGS

FIG. 1 shows schematically a box template production system according to one embodiment of the invention.

FIG. 2a shows schematically a perspective view of a box template production system according to another embodiment of the invention.

FIG. 2b shows a side view of the box template production system as shown in FIG. 2a.

FIG. 3a shows schematically a box template production system according to another embodiment of the invention.

FIG. 3b shows schematically a box template production system according to one embodiment of the invention which embodiment could be both the one shown in FIG. 1 and the one shown in FIGS. 2a and 2b.

FIG. 4 is a flow chart of a method according to one embodiment of the invention.

### DETAILED DESCRIPTION OF EMBODIMENTS

The invention relates to a box template production system comprising a converting part which is configured for converting a fanfolded sheet material into box templates. According to the invention said converting is accomplished to the sheet material when a feed direction of the sheet material through the converting part of the system is along an axis having an angle towards a plane of a floor onto which the system stands, wherein said angle is between 20 and 90 degrees or suitably between 30 and 70 degrees.

The sheet materials used for forming the box templates according to the invention could be e.g., paperboard, corrugated board or cardboard. The term cardboard is used in the text and claims and intends to cover all these examples. As used herein, the term “box template” shall refer to a substantially flat stock of material that can be folded into a box-like shape. A box template may have notches, cutouts, divides, and/or creases that allow the box template to be bent and/or folded into a box. Additionally, a box template may be made of any suitable material, generally known to those skilled in the art. For example, cardboard or corrugated paperboard may be used as the template material.

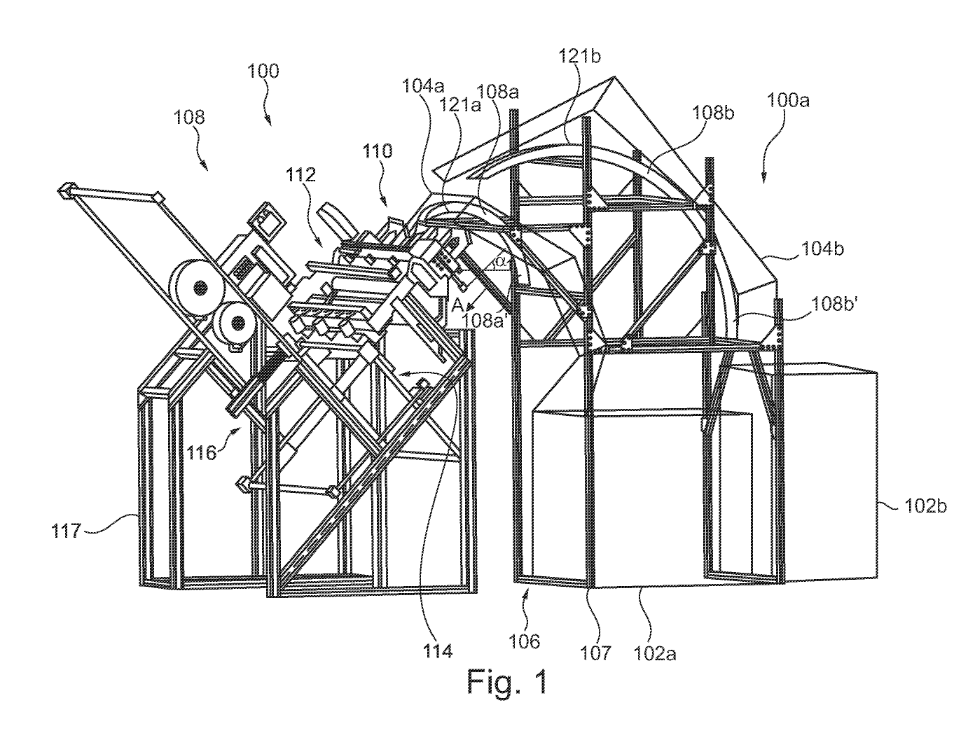

FIG. 1 illustrates schematically a perspective view of a box template production system 100 according to one embodiment of the invention. The system 100 is configured for receiving sheet material 104a, 104b from bales 102a, 102b of fanfolded sheet material 104a, 104b. One or more bales 102a, 102b can be provided side by side and/or in a queue at an inlet side 100a of the system 100. The bales 102a, 102b may be formed of sheet material 104a, 104b that have different characteristics (e.g., widths, lengths, thickness, stiffness, color, etc.) from one another. As illustrated in FIG. 1, for instance, the width of the bale 102a may be smaller than the width of the bale 102b. Thus, it may be desirable to use the sheet material 104a from the bale 102a to form a smaller box so there is less sheet material wasted.

The system 100 comprises a feeding part 106 provided for guiding the sheet material 104a, 104b into a processing part 108 of the system. The processing part 108 of the system comprises a frame 117 holding a converting part 112 and some other parts briefly described below. The converting part 112 converts the sheet material into box templates by for example cutting and creasing the material as described above. The feeding part 106 comprises a frame 107 which holds one or more feed guides 108a, 108b. In this shown embodiment two feed guides 108a, 108b are provided, one for each bale 102a, 102b. The feed guides 108a, 108b are configured for receiving the sheet material 104a, 104b from the fanfold bales 102a, 102b and guiding it up to a top position 121a, 121b, wherein the converting part 112 of the system is configured for receiving the sheet material 104a, 104b from the at least one feed guide 108a, 108b or from one or more connecting guide parts on its way down from the top position 121a, 121b. In this embodiment a feed changer 110 is provided between the feed guides 108a, 108b and the converting part 112 of the system.

The feed changer 110 is in this embodiment a connecting guide part between the feed guides 108a, 108b and the converting part 112 of the system. The feed changer 110 controls from which bale 102a, 102b sheet material 104a, 104b should be provided into the converting part 112 of the system 100. In another embodiment further connecting guide parts could be provided between the feed guides 108a, 108b and the converting part 112.

In this embodiment it can be seen that the converting part 112 of the system 100 is provided in a tilted position, i.e. the feed direction of a sheet material when passing through the converting part 112 is not parallel to a plane of the floor as is the case in prior art systems. As described in the claims the converting of the sheet material into a box template is accomplished to the sheet material when a feed direction of the sheet material through the converting part of the system is along an axis A having an angle α towards a plane of a floor onto which the system stands, wherein said angle α is between 20 and 90 degrees or suitably between 30 and 70 degrees. In the embodiment shown in FIG. 1 the angle α₁ is shown to be somewhere between 30 and 70 degrees. This will also be described as a tilted converting part in this patent application. The benefits in providing a tilted converting part is that less force will be required to guide the sheet material into the converting part compared to if the converting part is provided in a horizontal direction further down towards the floor. A horizontal direction requires further distances, bending and friction of the sheet material, i.e. the feed direction of the sheet material through the system needs to be changed more when the sheet material should enter a horizontally provided converting part than what is required for entering the tilted converting part of the system according to the invention.

In the embodiment of the invention shown in FIG. 1 only one feed guide 108a, 108b is provided for each sheet material 104a, 104b. This is however not necessary for the invention. A system having a tilted converting part 112 according to the invention could be provided with another type of feeding of the sheet material into the converting part 112, such as for example one or more rails or wheels for each sheet material. However in the embodiment shown in FIG. 1 said feed guide 108a, 108b is configured for receiving the sheet material 104a, 104b such that the sheet material is sliding over the feed guide. In this embodiment the feed guide 108a, 108b is positioned such that it touches the sheet material 104a, 104b somewhere in a middle third part of a width of the sheet material 104a, 104b. However this is more important for sheet materials having a larger width than for less wide sheet material. The at least one feed guide 108a, 108b is configured for allowing the sheet material 104a, 104b to tilt sideways around the feed guide 108a, 108b on its way up to the top position 121a, 121b thereby enabling correction of the feeding direction of the sheet material 104a, 104b. Compared to using for example two feed guides for the feeding of each sheet material it is easier to guide and correct directions of the sheet material when only one feed guide is provided. The material and surface of the feed guide 108a, 108b can be provided such that the sheet material 104a, 104b can slide over the feed guide and tilt sideways, such as for example low friction metal or plastic, or even a set of small wheels providing rolling friction rather than glide friction. This is in contrast to a material of a single larger wheel sometimes used for the feeding of sheet material into a converting part of the system.

Furthermore in the embodiment shown in FIG. 1 the at least one feed guide 108a, 108b is provided as an arc starting at a start position 108a′, 108b′ where the sheet material 104a, 104b is provided to the feed guide 108a, 108b, said arc further comprising the top position 121a, 121b. Said feed guide 108a, 108b can have a width being less than one fifth of the width of the sheet material. A wider feed guide would decrease the possibilities to tilt the sheet material sideways and change direction during the feeding. In this embodiment the arc continues after the top position 121a, 121b further down towards the feed changer 110 and the converting part 112. However the arc could in another embodiment end at the top position 121a, 121b and possibly be connected to the feed changer 110 or directly to the converting part 112 through another connecting guide part.

In the embodiment shown in FIG. 1 the processing part 108 of the system 100 also comprises a fold assembly 114, and an attachment assembly 116 which are mounted on or connected to the frame 117. These components are however not relevant for the present invention and will not be described in more detail here. In another embodiment of the invention no folding of boxes is provided in the system. The system only delivers box templates.

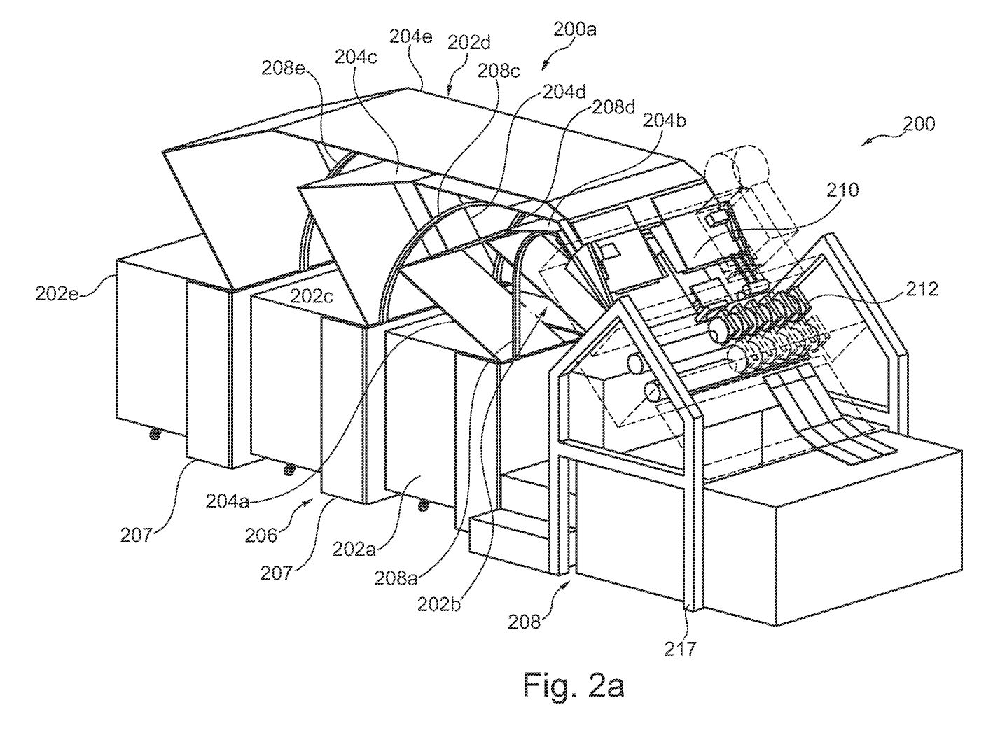

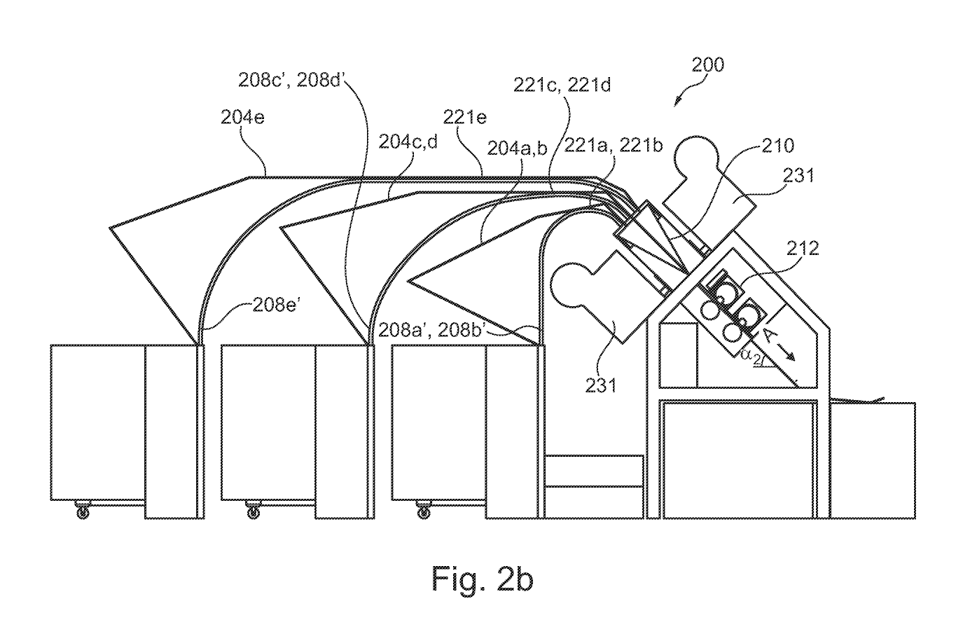

FIG. 2a shows schematically a perspective view of a box template production system 200 according to another embodiment of the invention. FIG. 2b shows the same embodiment as shown in FIG. 2a in a side view. In this embodiment a system 200 is provided without folding and assembling parts as shown in relation to FIG. 1. Many of the details in this embodiment are the same or very similar to the corresponding details in the embodiment shown in relation to FIG. 1 and these details will be given corresponding reference numbers but in the 200-series and will not be described in detail. A converting part 212 of the system is also in this embodiment tilted, i.e. the feed direction of a sheet material when transferred through and converted by the converting part 212 is along an axis A having an angle α towards a plane of the floor into which the system stands. This angle can be seen in FIG. 2b. The angle α₂ is in this embodiment between 30 and 70 degrees. In this embodiment of the system the system 200 is configured for receiving sheet material 204a-204e from bales 202a, 202b, 202c, 202d, 202e of fanfolded sheet material 204a-204e. One or more bales 202a, 202b, 202c, 202d, 202e can be provided side by side and/or in a row after each other at an inlet side 200a of the system 200. The bales 202a, 202b, 202c, 202d, 202e may be formed of sheet material 204a-204e that have different characteristics (e.g., widths, lengths, thickness, stiffness, color, etc.) from one another. As illustrated in FIGS. 2a and 2b, for instance, one to five different bales can provided at the same time to the system 200.

The system 200 comprises a feeding part 206 provided for guiding the sheet material 204a-204e into a processing part 208 of the system. The processing part 208 of the system comprises a frame 217 holding a converting part 212 and a feed changer 210. The converting part 112 converts the sheet material into box templates by for example cutting and creasing the material as described above. The feeding part 206 comprises a frame 207 which holds one or more feed guides 208a, 208b, 208c, 208d, 208e. In this shown embodiment five feed guides 208a, 208b, 208c, 208d, 208e are provided, one for each bale 202a, 202b, 202c, 202d, 202e. The feed guides 208a, 208b, 208c, 208d, 208e are configured for receiving the sheet material 204a-204e from the fanfold bales 202a, 202b, 202c, 202d, 202e and guiding it up to a respective top position 221a, 221b, 221c, 221d, 221e, wherein the converting part 212 of the system is configured for receiving the sheet material 204a-204e from the at least one feed guide 208a, 208b, 208c, 208d, 208e or from one or more connecting guide parts on its way down from the top position 221a, 221b, 221c, 221d, 221e. In this embodiment a feed changer 210 is provided between the feed guides 208a-208e and the converting part 212 of the system. The feed changer 210 is in this embodiment a connecting guide part between the feed guides 208a-208e and the converting part 212 of the system. The feed changer 210 controls from which bale 202a-202e sheet material 204a-204e should be provided into the converting part 212 of the system 200.

In the embodiment of the invention shown in FIGS. 2a and 2b only one feed guide 208a-208e is provided for each sheet material 204a-204e. Said feed guide 208a-208e is configured for receiving the sheet material 204a-204e such that the sheet material is sliding over the feed guide. In some embodiments the feed guides may be positioned such that they touch the sheet material 204a-204e somewhere towards a middle part of the width of the sheet material, possibly in a middle third part of a width of the sheet material 204a-204e. However this is more important for sheet materials having a larger width than for less wide sheet material. This is shown in FIG. 2a where the feed guide 208e is provided to receive sheet material 204a from the bale 202e substantially in the middle of the sheet material width. However some of the other feed guides 208a, 208c are not necessarily receiving the sheet material having a smaller width in a middle position. The at least one feed guide 208a-208e is configured for allowing the sheet material 204a-204e to tilt sideways around the feed guide 208a-208e on its way up to the top position 221a-221e thereby enabling correction of the feeding direction of the sheet material 204a-204e.

Furthermore in the embodiment shown in FIGS. 2a and 2b the at least one feed guide 208a-208e is provided as an arc starting at a start position 208a′-208e′ where the sheet material 204a-204e is provided to the feed guide 208a-208e, said arc further comprising the top position 221a-221e. Said feed guide 208a-208e can have a width being less than one fifth of the width of the sheet material. A wider feed guide would decrease the possibilities to tilt the sheet material sideways and change direction during the feeding. In this embodiment the arc continues after the top position 221a-221e further down towards the feed changer 210 and the converting part 212. However the arc could in another embodiment end at the top position 221a-221e.

In one embodiment of the invention the converting part 212 of the system 200 comprises a printer 231 configured and positioned for printing on the sheet material 204a-204e in a direction being perpendicular to the feed direction of the sheet material 204a-204e when the sheet material is converted in the converting part 212 of the system 200. In the embodiment shown in FIGS. 2a and 2b two printers 231 are shown, one for printing on each side of the sheet material when passing through the feed changer 210 and the converting part 212. The position of the printers 231 can be varied within the system 200 but the printing is suitably provided with the same tilt as the converting part 212. Printing to the sheet material 204a-e needs sometimes to be provided from the underside of the sheet material because this will often later form an outside of the box and printing from the underside may be complicated due to gravitational force and dirt and dust covering the printing heads. Hereby it is advantageous to provide the printer with a tilt as shown in this embodiment compared to some prior art systems where printing is provided directly from below in a horizontal position. A printer could also be provided to the embodiment shown in FIG. 1.

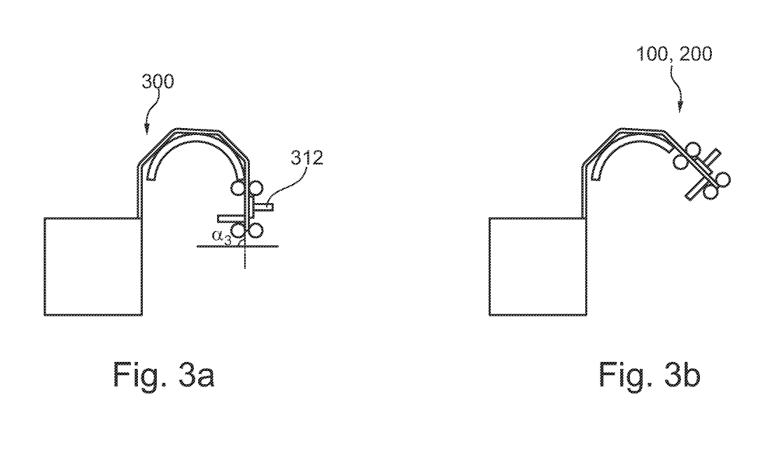

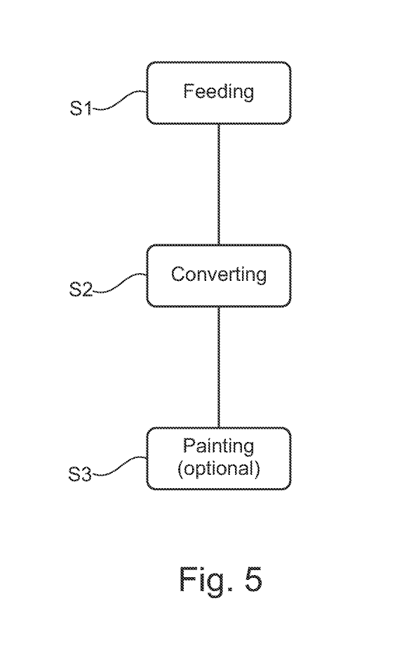

FIG. 3a shows schematically a box template production system 300 according to another embodiment of the invention. In this embodiment a converting part 312 of the system is provided in a vertical position, i.e. the feed direction of a sheet material through the converting part 312 of the system 300 is along an axis having an angle α towards a plane of a floor onto which the system stands, wherein said angle α₃ is 90 degrees.

FIG. 3b shows schematically a box template production system 100, 200 according to one embodiment of the invention which embodiment could be both the one shown in FIG. 1 and the one shown in FIGS. 2a and 2b.

FIG. 4 is a flow chart of a method for converting a fanfolded sheet material into a box template according to one embodiment of the invention. The method steps are described in order below:

S1: Feeding the sheet material 104a-b; 204a-e into a box template production system 100; 200, 300.

S3: Converting the sheet material 104a-b; 204a-e into box templates when a feed direction of the sheet material 104a-b; 204a-e through a converting part 112; 212; 312 of the box template production system 100; 200; 300 is along an axis having an angle towards a plane of a floor onto which the system stands, wherein said angle is between 20 and 90 degrees or in another embodiment between 30 and 70 degrees.

In one embodiment of the invention the step of feeding, S1, comprises guiding the sheet material 104a-b; 204a-e into the box template production system 100; 200; 300 by at least one feed guide 108a, 108b; 208a-208e, wherein said guiding comprises guiding the sheet material up to a top position 121a, 121b; 221a-221e and then further down from the top position to the converting part 112; 212; 312 of the system.

In one embodiment of the invention the step of feeding, S1, further comprises providing the sheet material 104a-b; 204a-e from at least one fanfold bale 102a, 102b; 202a-202e to only one feed guide 108a, 108b; 208a-208e for each sheet material 104a-b; 204a-e such that the feed guide 108a, 108b; 208a-208e is positioned somewhere in a middle third part of a width of the sheet material thus allowing the sheet material to tilt sideways around the feed guide on its way up to the top position thereby enabling correction of the feeding direction of the sheet material.

In one embodiment of the invention the method further comprises the optional step:

S5: Printing on the sheet material 104a-b; 204a-e in a direction being perpendicular to the feed direction of the sheet material when the sheet material is converted in the converting part 112; 212 of the system.

In another aspect of the invention a box template production system configured for converting a fanfolded sheet material into box templates is provided, wherein said box template production system comprises at least one feed guide configured for receiving sheet material from fanfold bales and guiding it up to a top position. In this aspect of the invention a conversion part of the system can be provided both tilted or not tilted, i.e. the converting of sheet material to a box template can be accomplished when a feed direction of the sheet material through the converting part of the system is along a floor plane or tilted as described above. In this aspect of the invention a converting part of the system is configured for receiving the sheet material from the at least one feed guide or from one or more connecting guide parts, wherein only one feed guide is provided for each sheet material and wherein said feed guide is configured for receiving the sheet material such that the sheet material slides over the feed guide. The at least one feed guide is configured for allowing the sheet material to tilt sideways around the feed guide on its way up to the top position thereby enabling correction of the feeding direction of the sheet material as described above.

In one embodiment of the invention the at least one feed guide is provided as an arc starting at a start position where the sheet material is provided to the feed guide, said arc further comprising the top position, wherein said feed guide has a width being less than one fifth of the width of the sheet material. The material and surface of the feed guide 108a, 108b; 208a-208e can be provided such that the sheet material 104a-b; 204a-e can slide over the feed guide and tilt sideways, such as for example low friction metal or plastics, or even a set of small wheels providing roller friction rather than glide friction.

1. A box template production system comprising a converting part which is configured for converting a fanfolded sheet material into box templates, wherein said converting is accomplished to the sheet material when a feed direction of the sheet material through the converting part of the system is along an axis having an angle (a) towards a plane of a floor onto which the system stands, wherein said angle (a) is between 20 and 90 degrees.

2. A box template production system according to claim 1, wherein said angle (a) is between 30 and 70 degrees.

3. A box template production system according to claim 1, wherein said fanfolded sheet material is provided to the system from at least one fanfold bale positioned at an inlet side of the system, wherein said box template production system comprises at least one feed guide configured for receiving the sheet material from the at least one fanfold bale and guiding it up to a top position, wherein the converting part of the system is configured for receiving the sheet material from the at least one feed guide or from one or more connecting guide parts on its way down from the top position.

4. A box template production system according to claim 3, wherein only one feed guide is provided for each sheet material and wherein said feed guide is configured for receiving the sheet material such that it slides over the feed guide.

5. A box template production system according to claim 3, wherein the at least one feed guide is configured for allowing the sheet material to tilt sideways around the feed guide on its way up to the top position thereby enabling correction of the feeding direction of the sheet material.

6. A box template production system according to claim 5, wherein the at least one feed guide is provided as an arc starting at a start position where the sheet material is provided to the feed guide, said arc further comprising the top position, wherein said feed guide has a width being less than one fifth of the width of the sheet material.

7. A box template production system according to claim 1, wherein the system further comprises a printer configured and positioned for printing on the sheet material in a direction being perpendicular to the feed direction of the sheet material when the sheet material is converted in the converting part of the system.

8. A method for converting a fanfolded sheet material into a box template, wherein said method comprises the steps of:
feeding (SI) the sheet material into a box template production system;
converting (S3) the sheet material into box templates when a feed direction of the sheet material through a converting part of the box template production system is along an axis (A) having an angle (a) towards a plane of a floor onto which the system stands, wherein said angle (a) is between 20 and 90 degrees.

9. A method according to claim 8, wherein said angle (a) is between 30 and 70 degrees.

10. A method according to claim 8, wherein the step of feeding (SI) comprises guiding the sheet material into the box template production system by at least one feed guide, wherein said guiding comprises guiding the sheet material up to a top position and then further down from the top position to the converting part of the system.

11. A method according to claim 10, wherein the step of feeding (SI) further comprises providing the sheet material from at least one fanfold bale to only one feed guide for each sheet material thus allowing the sheet material to slide over the feed guide and tilt sideways around the feed guide on its way up to the top position thereby enabling correction of the feeding direction of the sheet material.

12. A method according to any one of the claim 8, further comprising printing (S5) on the sheet material in a direction being perpendicular to the feed direction of the sheet material when the sheet material is converted in the converting part of the system.

13. A box template production system configured for converting a fanfolded sheet material into box templates, wherein said box template production system comprises at least one feed guide configured for receiving sheet material from fanfold bales and guiding it up to a top position, wherein a converting part of the system is configured for receiving the sheet material from the at least one feed guide or from one or more connecting guide parts, wherein only one feed guide is provided for each sheet material and wherein said feed is configured for receiving the sheet material such that it slides over the feed guide.

14. A box template production system according to claim 13, wherein the at least one feed guide is configured for allowing the sheet material to tilt sideways around the feed guide on its way up to the top position thereby enabling correction of the feeding direction of the sheet material.

15. A box template production system according to claim 13, wherein the at least one feed guide is provided as an arc starting at a start position where the sheet material is provided to the feed guide, said arc further comprising the top position, wherein said feed guide has a width being less than one fifth of the width of the sheet material.
